(19) United States
(12) Patent Application Publication
(10) Pub. No.: US 2025/0059075 A1
(43) Pub. Date: Feb. 20, 2025

(54) A METHOD AND APPARATUS FOR MONITORING BIOSLUDGE QUALITY IN WASTEWATER TREATMENT

(71) Applicant: Kemira Oyj, Helsinki (FI)

(72) Inventors: Edouard PAPIN, Trois-Rivières (CA); Marjatta PIIRONEN, Helsinki (FI); Iiris JOENSUU, Helsinki (FI); Rene BEAUDOIN, Québec (CA)

(21) Appl. No.: 18/721,670

(22) PCT Filed: Dec. 20, 2022
(86) PCT No.: PCT/FI2022/050851

§ 371 Date: Jun. 19, 2024

(30) Foreign Application Priority Data
Dec. 23, 2021 (FI) 20216341

(51) Int. Cl. C02F 3/00; C02F 1/00; C02F 1/52

(52) U.S. Cl. CPC C02F 3/006; C02F 1/5209; C02F 2001/007; C02F 2209/11; C02F 2209/40

(57) ABSTRACT

A method for monitoring biosludge quality in a wastewater process. The method comprises determining in an in-situ analysis a first set of parameter values indicative of settled turbidity and a second set of parameter values indicative of settling speed of wastewater process samples over a period of time, correlating the first and second sets with respective values indicative of sludge volume index, and monitoring the biosludge quality on the basis of the correlating step.

### TECHNICAL FIELD

The present disclosure generally relates to water treatment. The disclosure relates particularly, though not exclusively, to a method and apparatus for monitoring biomass sludge quality in a wastewater treatment process.

### BACKGROUND

This section illustrates useful background information without admission of any technique described herein representative of the state of the art.

Wastewater treatment plants are used to purify municipal sewage and/or industrial wastewater. In a conventional wastewater treatment plant, wastewater flows first to a mechanical preliminary treatment where different objects are removed from the wastewater, typically by one or more screens of different size. After the mechanical preliminary treatment, the wastewater flows into a primary treatment tank or tanks. The primary treatment is typically based on sedimentation of particles in the wastewater. The wastewater then enters a secondary treatment that is based on biological processes. These processes use bacteria which consume contaminants, in particular biodegradable organics, carbon and phosphorus and some nitrogen. Biomass with organic and/or inorganic residue forms biomass sludge. The biomass sludge settles on the bottom of a secondary sedimentation tank from which the sludge is either guided back for re-use in the biological processes or separated for further processing. The outlet stream of water from the secondary sedimentation tank may be clean enough to be released to a recipient, or it may undergo further purification step(s), generally referred to as a tertiary treatment.

In the disclosed water treatment process, the quality of the biomass sludge is important so that the process runs as intended. The quality of the biomass sludge is monitored via laboratory experiments, typically once a day. Especially, a sludge volume index (SVI) is an important indicator of the biomass sludge quality.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

It is an object of certain embodiments of the invention to provide an improved method for monitoring biomass sludge quality in a water treatment system or plant or at least to provide an alternative solution to existing technology.

According to a first example aspect of the invention there is provided a method for monitoring biosludge quality in a wastewater process, comprising:
determining in an in-situ analysis a first set of parameter values indicative of settled turbidity and a second set of parameter values indicative of settling speed of wastewater process samples over a period of time;
correlating the first and second sets with respective values indicative of sludge volume index; and
monitoring the biosludge quality on the basis of the correlating step.

The sludge volume index, SVI, is the well-known parameter typically defining the volume, in milliliters, of 1 gram of suspended solids after 30 minutes of settling. The SVI is obtained in laboratory conditions by performing two tests, a settleability test and a mixed liquor suspended solids test, and by preforming mathematical calculations based on the tests.

In certain embodiments, the wastewater process samples are taken from an outlet stream of biological treatment of the wastewater or from an inlet stream of a secondary sedimentation of the wastewater.

In certain embodiments, the in-situ analysis comprises an online in-situ settling experiment in an online in-situ analysis equipment. The term in-situ herein means analysis, experiment and equipment located in connection with the wastewater process, in contrast to analysis, experiment and equipment located in a laboratory.

In certain embodiments, a parameter value indicative of settled turbidity is expressed by a final turbidity value at the end of a measurement period in a settling experiment, or by an indexed value, for example, an unsettled floc index herein defined as the final turbidity value divided by a fixed number. Accordingly, in certain embodiments, the first set of parameter values indicative of settled turbidity are indexed values, such as values of an unsettled floc index.

In certain embodiments, a parameter value indicative of settling speed is expressed by a slope of a curve measuring turbidity as a function of time in a settling experiment (a measured difference in turbidity divided by a respective difference in time).

In certain embodiments, the method comprises:
providing a sampling water stream from a sampling point downstream of an aeration tank in a wastewater stream to the analysis equipment.

In certain embodiments, the method comprises:
determining limits or an operating window for the parameter indicative of settled turbidity and the parameter indicative of settling speed on the basis of a target range of the sludge volume index.

In certain embodiments, said monitoring of biosludge quality comprises monitoring whether the parameter indicative of settled turbidity and the parameter indicative of settling speed stay below the determined limits or within the operating window.

In certain embodiments, the method comprises, in the event said parameter indicative of settled turbidity or the parameter indicative of settling speed does not stay below the determined limit(s) or within the operating window:
alerting an operator; and/or
providing an operator with instructions; and/or
providing a direct control signal to control the wastewater process.

In certain embodiments, the method comprises controlling the biosludge quality with at least one of the following:
controlling a ratio of return sludge flow based on said monitoring;
controlling process conditions of the biological treatment based on said monitoring;
controlling treatment chemical(s) (such as a coagulant and/or a flocculant) dose to secondary sedimentation based on said monitoring.

In certain embodiments, the ratio of return sludge flow is defined as a returned activated sludge (RAS) flow rate ratio wherein the return sludge flow is proportional to wastewater influent flow. In certain embodiments, the RAS flow rate is controlled as a constant percentage of the influent flow.

In certain embodiments, the method comprises:
stabilizing a sample within an analysis vessel in the analysis equipment during a stabilization period, prior to commencing the settling experiment, by flowing sampling water from an analysis vessel inlet through the analysis vessel to an analysis vessel outlet for a stabilization period.

According to a second example aspect there is provided an apparatus, comprising:
at least one processor; and
at least one memory including computer program code, the at least one memory and the computer program code being configured, with the at least one processor, to cause the apparatus to perform the method of any of the first aspect or any related embodiment.

According to a third example aspect of the present invention, there is provided a computer program comprising computer executable program code which when executed by a processor causes an apparatus to perform the method of the first aspect or any related embodiment.

According to a fourth example aspect there is provided a computer program product comprising a non-transitory computer readable medium having the computer program of the third example aspect stored thereon.

According to a fifth example aspect there is provided an apparatus comprising means for performing the method of the first aspect or any related embodiment.

Any foregoing memory medium may comprise a digital data storage such as a data disc or diskette, optical storage, magnetic storage, holographic storage, opto-magnetic storage, phase-change memory, resistive random-access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments apply to other example aspects as well.

### BRIEF DESCRIPTION OF THE FIGURES

Some example embodiments will be described with reference to the accompanying figures, in which:

FIG. 1 schematically shows certain parts of a wastewater treatment plant according to certain example embodiments;

FIG. 2 schematically shows a flow chart according to certain example embodiments;

FIG. 3 schematically shows a block diagram of an apparatus according to certain example embodiment;

FIG. 4 shows certain examples of determining the settling speed and the unsettled floc index;

FIG. 5 shows observed correlation between SVI and a unsettled floc index;

FIG. 6 shows observed correlation between SVI and settling speed;

FIG. 7 shows observed correlation between SVI and unsettled floc index below SVI values 250 ml/g;

FIG. 8 shows observed correlation between SVI and unsettled floc index above SVI values 250 ml/g;

FIG. 9 shows observed correlation between SVI and settling speed below SVI values 250 ml/g;

FIG. 10 shows observed correlation between SVI and settling speed above SVI values 250 ml/g;

FIG. 11 shows values of settling speed in the function of SVI;

FIG. 12 shows values of unsettled floc index in the function of SVI;

FIG. 13 shows the determination of an operation window in accordance with certain embodiments; and

FIG. 14 schematically shows a flow chart according to yet further embodiments.

### DETAILED DESCRIPTION

In the following description, like reference signs denote like elements or steps.

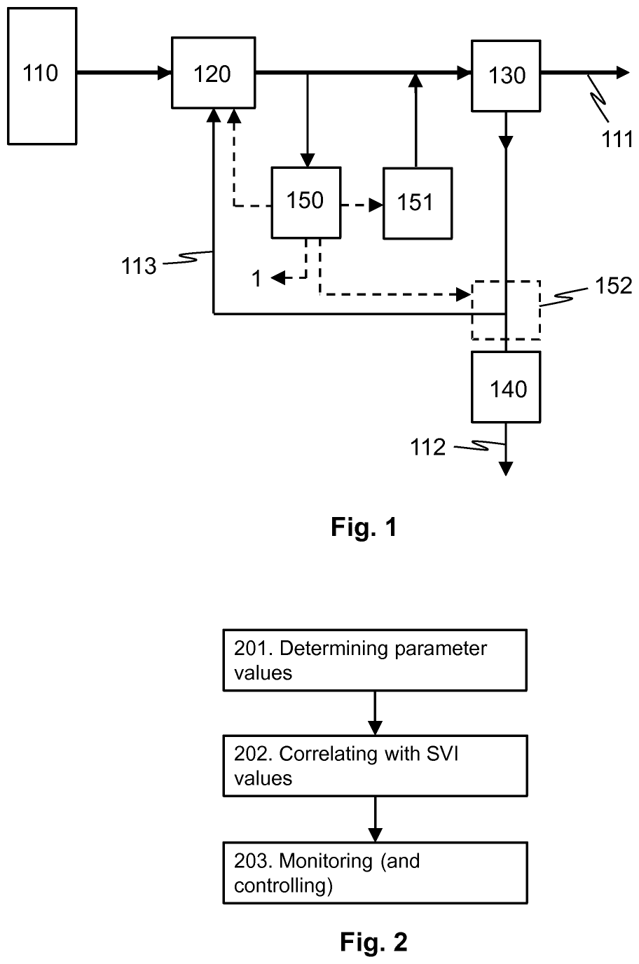

FIG. 1 schematically shows certain parts of a wastewater treatment plant according to certain example embodiments. The wastewater treatment plant (or system) shown may be a wastewater treatment plant to purify municipal sewage and/or industrial wastewater. The wastewater to be purified first flows to a mechanical preliminary treatment where different objects are removed from the wastewater, typically by one or more screens of different size. After the mechanical preliminary treatment, the wastewater flows into a primary treatment tank or tanks 110. The primary treatment 110 is typically based on sedimentation of particles in the wastewater. The wastewater then enters a secondary treatment that is based on biological processes. These processes use bacteria which consume contaminants, in particular biodegradable organics, carbon and phosphorus and some nitrogen. The secondary treatment comprises treatment by an aerobic treatment unit 120 followed by a solid-liquid separation unit, such as a sedimentation tank 130. Biomass with organic and/or inorganic residue forms biomass sludge. The biomass sludge settles on the bottom of the secondary sedimentation tank 130 from which the sludge is either guided back for re-use in the biological processes or separated for further processing. Accordingly, the sludge is guided via a return sludge control unit 152 to a sludge thickening unit 140 that produces a biomass sludge outlet 112 or to a return sludge line 113 guiding the sludge back to biological processes.

The outlet stream 111 of water from the secondary sedimentation tank may be clean enough to be released to a recipient, or it may undergo further purification step(s), generally referred to as a tertiary treatment.

The system further comprises an analysis equipment 150 that receives water samples from an outlet stream of biological treatment. In practice, a suitable point of taking samples may be from an inlet stream of the secondary sedimentation of the wastewater or at a point downstream from the aerobic treatment unit 120 (or an aeration tank). The analysis equipment 150 is an online in-situ analysis equipment (in contrast to offline laboratory analysis equipment), and the analysis equipment is capable of performing an online in-situ settling experiments (or analysis) on the water samples. The settling experiments are online experiments in the sense that they are performed on site and typically on samples that form a side stream of the actual wastewater treatment process. As an example, the settling experiments may be, e.g., 10 min or 30 min experiments.

The analysis equipment 150 produces a first set of parameter values indicative of settled turbidity and a second set of parameter values indicative of settling speed of wastewater process samples over a period of time. These parameter values are compared to respective values of the sludge volume index, SVI, to obtain conclusions regarding their behavior. In other words, the first and second sets are correlated with respective values indicative of SVI. Further, the biosludge (biomass sludge) quality is monitored on the basis of the detected correlation. Yet further, the biosludge quality is controlled based on said monitoring.

In certain embodiments, limits or an operating window for the parameter indicative of settled turbidity and the parameter indicative of settling speed are determined on the basis of a target range of the sludge volume index. In certain embodiments, the monitoring of biosludge quality then comprises monitoring whether the parameter indicative of settled turbidity and the parameter indicative of settling speed stay below the determined limits or within the operating window. The SVI is a rather slow indicator of biosludge quality. Once the correlation between the parameter indicative of settled turbidity and the parameter indicative of settling speed with the SVI has been learned, early warnings concerning the biosludge quality can be more rapidly obtained by monitoring the said parameters.

In certain embodiments, if the parameter indicative of settled turbidity or the parameter indicative of settling speed does not stay below the determined limit(s) or within the operating window, the operator 1 of the wastewater process is alerted (or instructions are provided to the operator 1), or a direct control signal to control the wastewater process is provided. In certain embodiments, the return sludge control unit 152 is controlled to affect the amount of return sludge returning to the biological processes via the return sludge line 113. In certain embodiments, the ratio of return sludge flow is controlled. In certain embodiments, the ratio of return sludge flow is defined as a returned activated sludge (RAS) flow rate ratio wherein the return sludge flow is proportional to wastewater influent flow. A typical value of the RAS flow rate ratio is 20-40%. In certain embodiments, the RAS flow rate is controlled as a constant percentage of the influent flow.

In certain embodiments, a treatment chemical dozer 151 dosing a polymer and/or another treatment chemical(s) dose to the inlet stream of the secondary sedimentation tank 130 is controlled. In further embodiments, process conditions of the biological treatment are controlled (for example, nutrients dose, air feed, and/or temperature may be controlled) based on said monitoring. The purpose of the control is to cause the parameter indicative of settled turbidity and the parameter indicative of settling speed to stay (or return) within limits and thereby ensure that the biological processes function as intended.

The treatment chemical(s) comprise at least one of a coagulant and a flocculant. Treatment chemicals may be added as a mixture or separately.

Treatment chemical(s) are fed into the secondary treatment process of wastewater for solids removal, wastewater clarification and removal of dissolved impurities (like organic compounds, phosphorus).

Treatment with a coagulant typically neutralizes the negative electrical charge on particles and/or dissolved impurities, which destabilizes the forces keeping colloids apart. Flocculation is typically a process of agglomerating destabilized particles into bigger flocs. In wastewater flocculation, colloidal particles are flocked in order to aid their removal. Flocculants can be used alone or together with coagulants to make flocs bigger and more resistant to shear forces.

A flocculant can be a cationic, anionic or nonionic polymer. Said polymers can be synthetic or natural organic polymers. Typical synthetic organic polymers used in flocculation process are different polyacrylamides (cationic, anionic or nonionic polyacrylamides) with a wide range of charge and molecular weight. Synthetic organic polymers comprise polyacrylamide, polyamine, polyDADMAC, polyethyleneimine, dicyandiamide and polyvinyl amine. Natural organic polymers comprise polysaccharide, such as starch, cellulose, guar gum, chitosan, dextran and the like, and polyphenolics, such as tannin and lignin.

Coagulants comprise iron containing salts, aluminum containing salts, magnesium containing salts, and any derivative thereof, preferably chlorides, sulphates, chlorosulphates, chlorohydrates, silicates, nitrates, and any derivate thereof, more preferably aluminum sulfate, polyaluminum sulfate, aluminum chloride, polyaluminum chloride, polyaluminum chlorosulfate, polyaluminum hydroxychlorosulfate, aluminum chlorohydrate, sodium aluminate, ferric sulfate, polyferric sulfate, ferric chloride, ferric chlorosulphate, polyferric chloride, ferrous sulfate, ferrous chlorosulphate, ferrous chloride, aluminum triformate, polyaluminum formate, polyaluminum nitrate, polyaluminum silicate, magnesium chloride, any derivative thereof, and any combination thereof.

FIG. 2 schematically shows a flow chart according to certain example embodiments. In step 201, parameter values indicative of settled turbidity and indicative of settling speed are obtained. Similarly, respective values of SVI are obtained in a manner know as such. In step 202, a correlation of the parameter values indicative of settled turbidity and indicative of settling speed with SVI values is formed. And, in step 203, biosludge quality is monitored (and controlled in certain embodiments) based on the correlation.

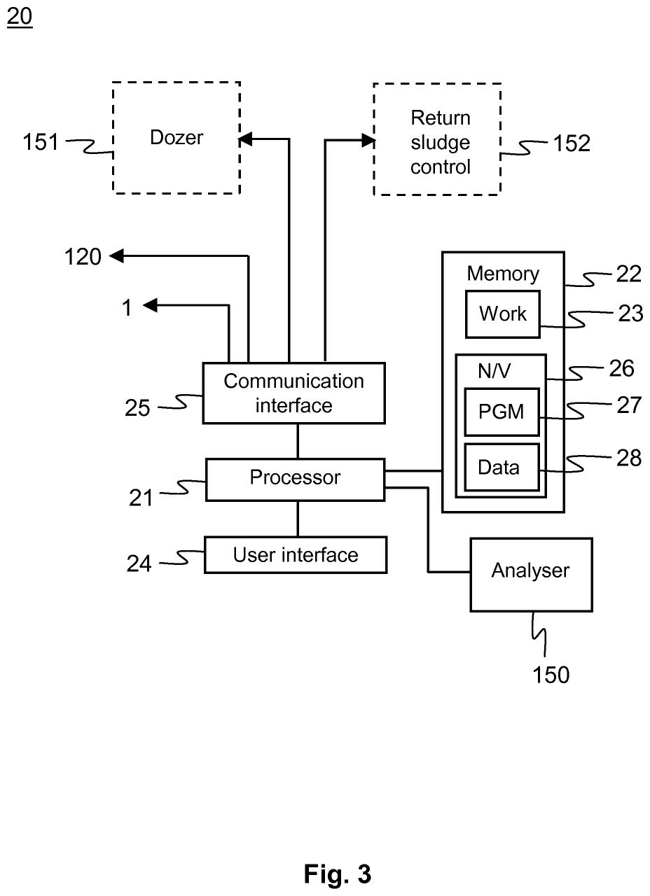

FIG. 3 shows a block diagram of a control apparatus 20 according to an embodiment. The apparatus 20 is suitable for implementing at least some of the operations disclosed in the preceding. The apparatus 20 comprises for example a general-purpose computer or server or some other electronic data processing apparatus. The apparatus 20 further comprises the analysis equipment 150, although in some other embodiments the whole apparatus 20 may be understood to form part of the analysis equipment 150 (in which case the analysis equipment 150 is considered to implement the functions of the control apparatus 20 disclosed herein).

The apparatus 20 comprises a communication interface 25, a processor 21, a user interface 24, and a memory 22.

The communication interface 25 comprises in an embodiment a wired and/or wireless communication circuitry, such as Ethernet, Wireless LAN, Bluetooth, GSM, CDMA, WCDMA, LTE, and/or 5G circuitry. The communication interface can be integrated in the apparatus 20 or provided as a part of an adapter, card or the like, that is attachable to the apparatus 20. The communication interface 25 may support one or more different communication technologies. The apparatus 20 may also or alternatively comprise more than one communication interface 25.

The processor 21 may be a central processing unit (CPU), a microprocessor, a digital signal processor (DSP), a graphics processing unit, an application specific integrated circuit (ASIC), a field programmable gate array, a microcontroller or a combination of such elements.

The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 comprises a work memory 23 and a persistent (non-volatile, N/V) memory 26 configured to store computer program code 27 and data 28. The memory 26 may comprise any one or more of: a read-only memory (ROM), a programmable read-only memory (PROM), an erasable programmable read-only memory (EPROM), a random-access memory (RAM), a flash memory, a data disk, an optical storage, a magnetic storage, a smart card, a solid state drive (SSD), or the like.

The apparatus 20 may comprise a plurality of memories 26. The memory 26 may be constructed as a part of the apparatus 20 or as an attachment to be inserted into a slot, port, or the like of the apparatus 20 by a user or by another person or by a robot. The memory 26 may serve the sole purpose of storing data, or be constructed as a part of an apparatus 20 serving other purposes, such as processing data.

A skilled person appreciates that in addition to the elements shown in FIG. 2, the apparatus 20 may comprise other elements, such as microphones, displays, as well as additional circuitry such as an input/output (I/O) circuitry, memory chips, application-specific integrated circuits (ASIC), a processing circuitry for specific purposes such as a source coding/decoding circuitry, a channel coding/decoding circuitry, a ciphering/deciphering circuitry, and the like. Additionally, the apparatus 20 may comprise a disposable or rechargeable battery (not shown) for powering the apparatus 20 if an external power supply is not available. Further, it is noted that only one apparatus 20 is shown in FIG. 3, but certain embodiments may equally be implemented in a cluster of shown apparatuses.

The apparatus 20 determines (or measures) the first set of parameter values indicative of settled turbidity and the second set of parameter values indicative of settling speed, received respective SVI values, correlates the first and second sets with the respective SVI values, and monitoring the biosludge quality on the basis of the correlation. Further, the apparatus 20 alerts the user 1 via the communication interface 25 or via the user interface 24, provides the aerobic treatment unit 120 with the required process control in certain embodiments, provides the dozer 151 with the required control in certain embodiments, and provides the return sludge control unit 152 with the required control in certain embodiments. The dozer 151 and/or the return sludge control unit 152 are implemented as parts contained by the apparatus 20 in certain embodiments. The control unit 152 would typically contain a valve or valves with its/their controlling elements.

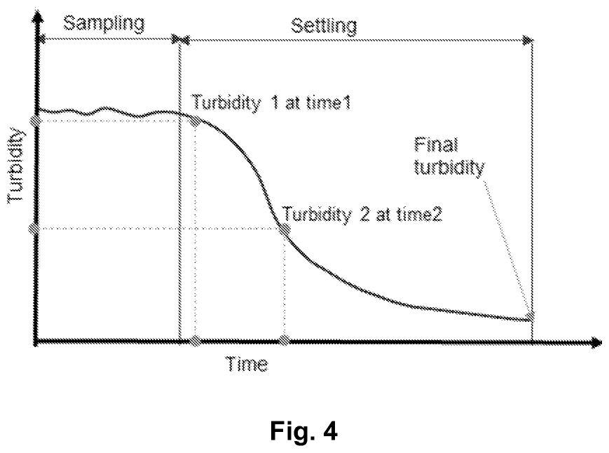

In the preceding, a parameter indicative of settled turbidity and a parameter indicative of settling speed have been discussed. FIG. 4 shows certain examples of determining the settling speed and a parameter indicative of the settled turbidity, an unsettled floc index. As mentioned, the analysis equipment 150 receives water samples for a settling experiment. After a sampling period, the settling experiment is started, and turbidity values of the sample are measured. After a certain period of time a main slope in settling is entered. The slope, i.e., the value (turbidity 1 at time1−turbidity 2 at time2)/(time2−time1) in this section representing the change in turbidity over time is determined as the settling speed. Further, after a period of time the settling more or less saturates. A measured “settled” turbidity value is divided by a fixed number to obtain an index value (scaled end turbidity) that describes the amount of remaining unsettled particles/flocs, herein denoted as the unsettled floc index. Said “fixed number” herein depends on the implementation. In certain embodiments, the fixed number is a maximum long-term value of turbidity measured from the wastewater stream (or sampling water stream representing the wastewater stream). The long-term in certain embodiments is a time period of 1 month, a few months, or a year.

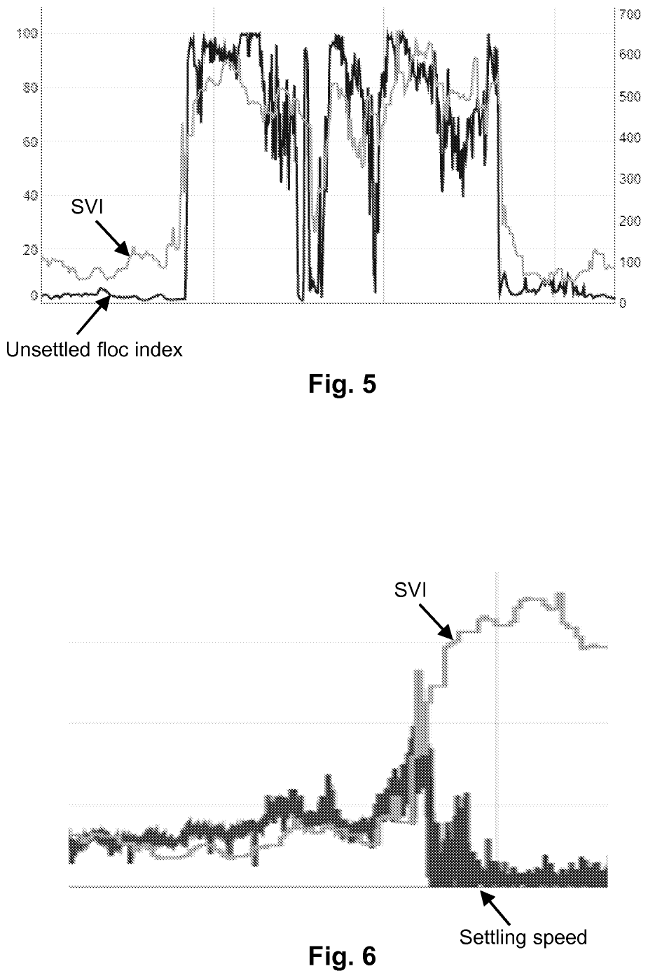

FIG. 5 shows an observed correlation between SVI and the unsettled floc index. It was observed that high unsettled floc index values correlate with high SVI values.

FIG. 6 shows an observed correlation between SVI and settling speed. It was observed that the settling speed correlates to SVI when the SVI was up to ˜250. When the SVI was higher than ˜250, settling speed dropped due to the high amount of unsettled flocs. This may indicate filamentous sludge bulking. Further, it was observed that the settling speed started to increase before the SVI values started to increase. This information was useful in considering an early warning.

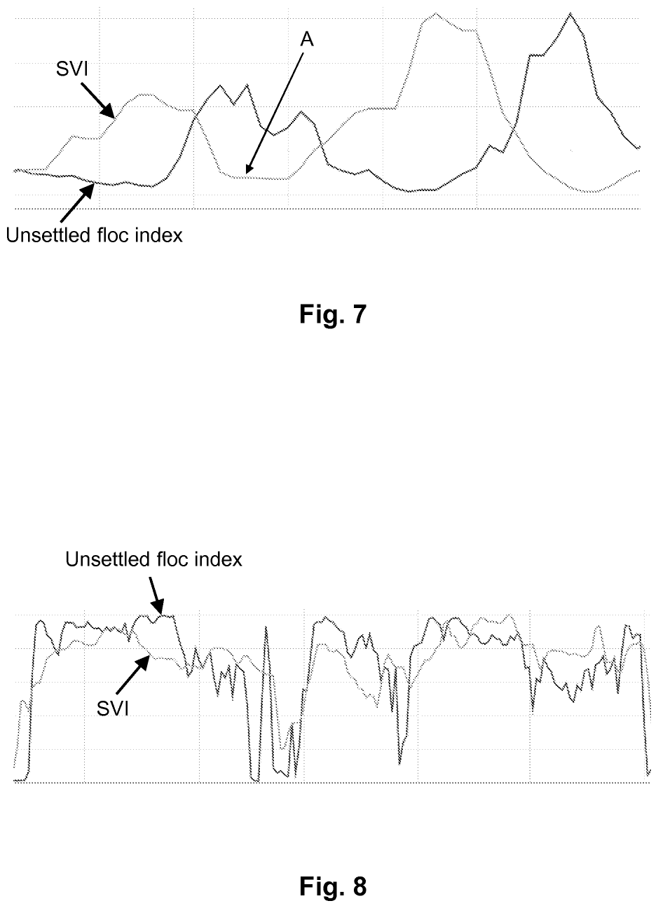

FIG. 7 shows an observed correlation between SVI and unsettled floc index below SVI values 250 ml/g, and FIG. 8 shows an observed correlation between SVI and unsettled floc index above SVI values 250 ml/g. It was observed that when SVI<250 ml/g, it applied that when the unsettled floc index increased the SVI decreased, whereas when SVI>250 ml/g, it applied that when the unsettled floc index increased also the SVI increased. In FIG. 7 it is noted that at the area marked by “A” the SVI<100 ml/g. In this area the sludge settles very rapidly and forms a dense big floc that does not trap many particles. This can be seen as an increase in the unsettled floc index.

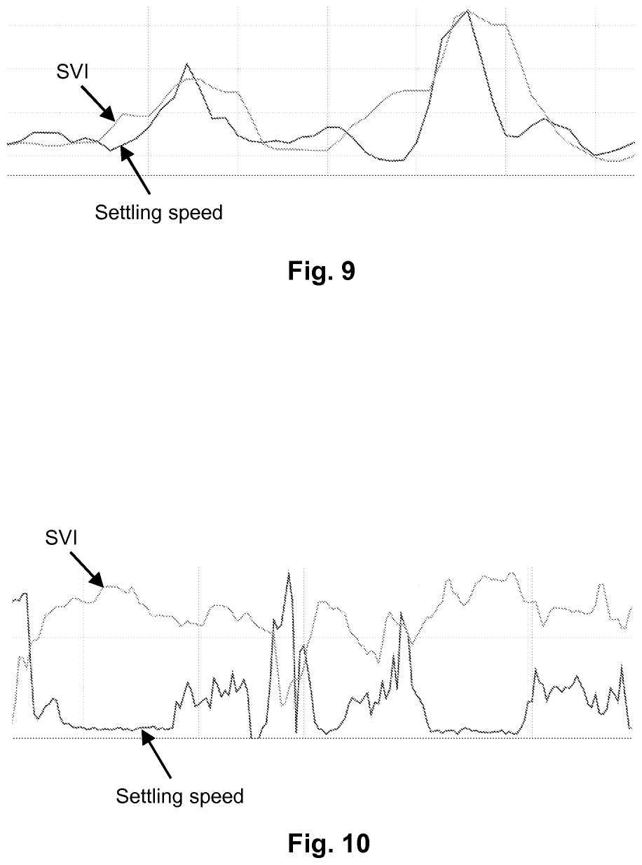

FIG. 9 shows an observed correlation between SVI and settling speed below SVI values 250 ml/g, and FIG. 10 shows an observed correlation between SVI and settling speed above SVI values 250 ml/g. It was observed that when SVI<250 ml/g, it applied that when the settling speed increased also the SVI increased, whereas when SVI>250 ml/g, it applied that when the settling speed increased the SVI decreased.

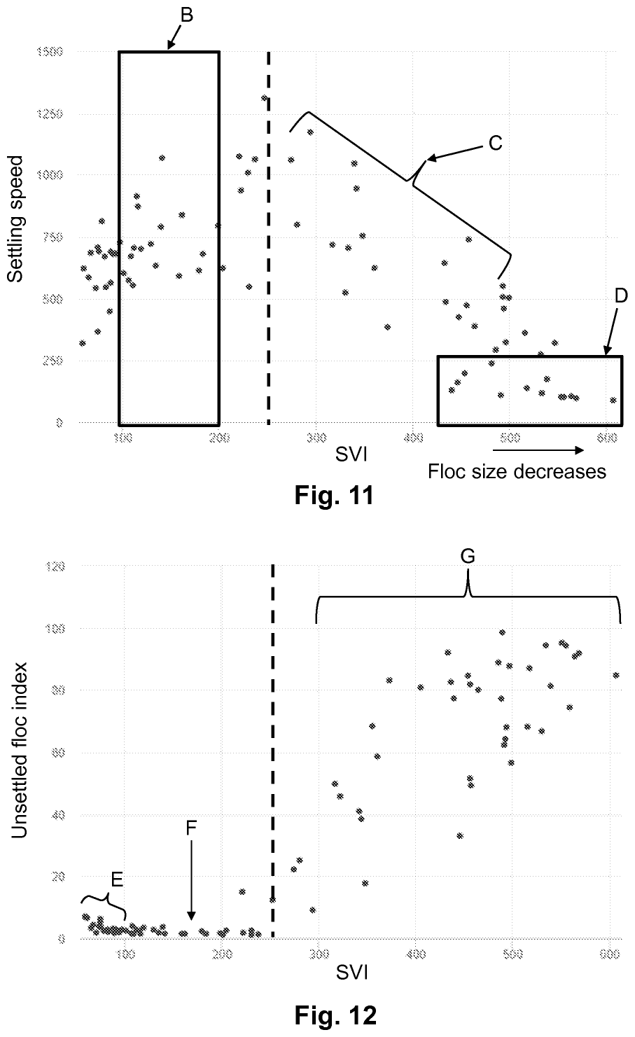

FIG. 11 shows values of settling speed in the function of SVI. It is noted that the area marked by “B” represents a preferred operation window where SVI ranges from 100 to 200. In this area the sludge settles and traps particles well (the unsettled floc index has a small value). When the SVI increases (in the area “C” where SVI>250) the settling properties become less optimal. This can be seen as a decrease in the settling speed (the unsettled floc index respectively increases). In the area D, the sample in practice does not settle at all.

FIG. 12 shows values of unsettled floc index in the function of SVI. It is noted that the area marked by “F” represents an optimal area with respect to sludge quality when the unsettled floc index has its minimum. At the area marked by “E” the SVI<100 ml/g. In this area the sludge settles very rapidly and forms a dense big floc that does not trap many particles. This can be seen as an increase in the unsettled floc index. When the SVI increases (in the area “G” where SVI>250) the settling properties become less optimal. This can be seen as an increase in the unsettled floc index (the settling speed respectively decreases).

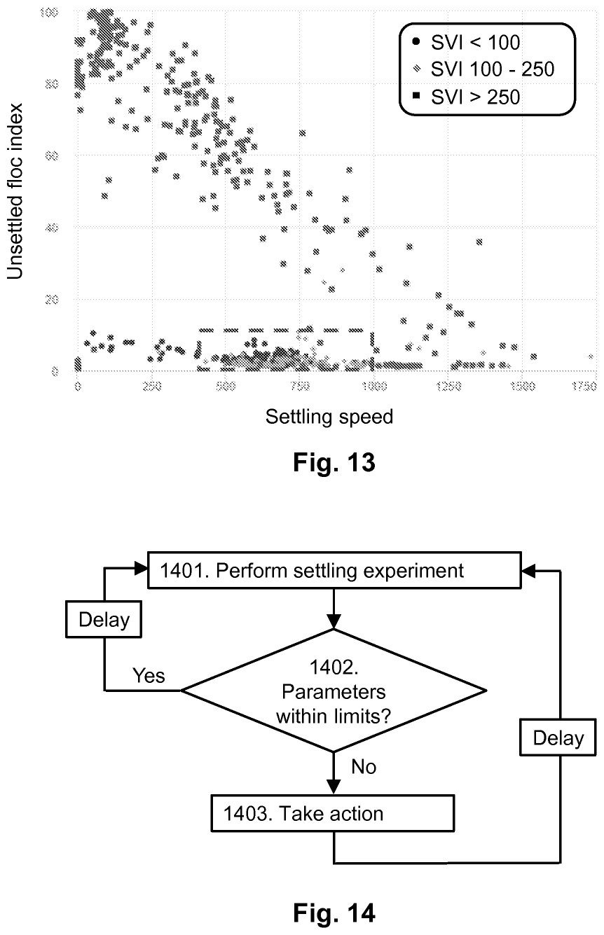

FIG. 13 shows the determination of an (optimal) operation window in accordance with certain embodiments. The optimal operating window is obtained when SVI is in its optimal area between 100 and 200 mL/g. In this area the sludge will settle slowly enough, trapping more particulate matter during the settling process than for example sludge in the area with SVI below 100 mL/g. In the presented example, the settling speed 500-1000 NTU/min and the unsettled floc index <5 or <10 will best fit into the optimal SVI area.

FIG. 14 shows a method of using the determined operation window in monitoring and controlling the biosludge quality in certain embodiments. In phase 1401, a settling experiment is performed. In phase 1402, it is determined whether or not the settling speed and unsettled floc index are within the window. If yes, no action is taken, but the settling experiment is repeated after a pre-determined delay. If no, appropriate action is taken, and a new settling experiment is performed, again after a predetermined period of time (delay).

In the foregoing embodiments the treated wastewater may comprise municipal wastewater and/or industrial wastewater, such as wastewater from pulp and paper industry, food industry, oil industry, mining industry or other applicable industry.

Various embodiments have been presented. It should be appreciated that in this document, words comprise, include and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method for monitoring biosludge quality in a wastewater process, comprising:
determining in an in-situ analysis a first set of parameter values indicative of settled turbidity and a second set of parameter values indicative of settling speed of wastewater process samples over a period of time;
correlating the first and second sets with respective values indicative of sludge volume index; and
monitoring the biosludge quality on the basis of the correlating step.

2. The method of claim 1, wherein the first set of parameter values indicative of settled turbidity are indexed values, such as values of an unsettled floc index.

3. The method of claim 1, wherein the wastewater process samples are taken from an outlet stream of biological treatment of the wastewater or from an inlet stream of a secondary sedimentation of the wastewater.

4. The method of claim 1, wherein the in-situ analysis comprises an online in-situ settling experiment in an online in-situ analysis equipment.

5. The method of claim 4, comprising:
providing a sampling water stream from a sampling point downstream of an aeration tank in a wastewater stream to the analysis equipment.

6. The method of claim 1, comprising:
determining limits or an operating window for the parameter indicative of settled turbidity and the parameter indicative of settling speed on the basis of a target range of the sludge volume index.

7. The method of claim 6, wherein said monitoring of biosludge quality comprises monitoring whether the parameter indicative of settled turbidity and the parameter indicative of settling speed stay below the determined limits or within the operating window.

8. The method of claim 6, comprising, in the event said parameter indicative of settled turbidity or the parameter indicative of settling speed does not stay below the determined limit(s) or within the operating window:
alerting an operator; and/or
providing an operator with instructions; and/or
providing a direct control signal to control the wastewater process.

9. The method of claim 1, comprising controlling the biosludge quality with at least one of the following:
controlling a ratio of return sludge flow based on said monitoring;
controlling process conditions of the biological treatment based on said monitoring;
controlling treatment chemical(s) dose to secondary sedimentation based on said monitoring.

10. An apparatus, comprising:
at least one processor; and
at least one memory including computer program code, the at least one memory and the computer program code being configured, with the at least one processor, to cause the apparatus to perform the method of claim 1.

11. A computer program comprising computer executable program code which when executed by a processor causes an apparatus to perform the method of claim 1.

12. The method of claim 2, wherein the wastewater process samples are taken from an outlet stream of biological treatment of the wastewater or from an inlet stream of a secondary sedimentation of the wastewater.

13. The method of claim 2, wherein the in-situ analysis comprises an online in-situ settling experiment in an online in-situ analysis equipment.

14. The method of claim 3, wherein the in-situ analysis comprises an online in-situ settling experiment in an online in-situ analysis equipment.

15. The method of claim 2, comprising:
determining limits or an operating window for the parameter indicative of settled turbidity and the parameter indicative of settling speed on the basis of a target range of the sludge volume index.

16. The method of claim 3, comprising:
determining limits or an operating window for the parameter indicative of settled turbidity and the parameter indicative of settling speed on the basis of a target range of the sludge volume index.

17. The method of claim 4, comprising:
determining limits or an operating window for the parameter indicative of settled turbidity and the parameter indicative of settling speed on the basis of a target range of the sludge volume index.

18. The method of claim 5, comprising:
determining limits or an operating window for the parameter indicative of settled turbidity and the parameter indicative of settling speed on the basis of a target range of the sludge volume index.
